(19) United States
(12) Patent Application Publication
(10) Pub. No.: US 2024/0234731 A1
(43) Pub. Date: Jul. 11, 2024

(54) SECONDARY BATTERY AND ELECTRONIC DEVICE

(71) Applicant: Ningde Amperex Technology Limited, Ningde (CN)

(72) Inventors: Chun LI, Ningde (CN); Meifeng CHEN, Ningde (CN)

(73) Assignee: Ningde Amperex Technology Limited, Ningde (CN)

(21) Appl. No.: 18/400,173

(22) Filed: Dec. 29, 2023

(30) Foreign Application Priority Data
Dec. 31, 2022 (CN) 202211734863.2

(51) Int. Cl. H01M 4/62; H01M 4/04; H01M 10/00

(52) U.S. Cl. CPC H01M 4/62; H01M 4/0471; H01M 10/00; H01M 2004/021

(57) ABSTRACT

An secondary battery including a positive electrode plate. The positive electrode plate includes a positive current collector and a positive active material layer disposed on at least one side of the positive current collector. The positive active material layer includes a positive active material and a resin-based additive. Based on a mass of the positive active material layer, a mass percent of the resin-based additive is m %, where 0.1≤m≤2. After baking, a cohesive force of the positive active material layer on the positive electrode plate of this application is increased, and a resistance of the positive electrode plate increases after being baked.

### CROSS-REFERENCE TO RELATED APPLICATION

The present application claims the benefit of priority from the Chinese Patent Application No. 202211734863.2, filed on Dec. 31, 2022, the disclosure of which is hereby incorporated by reference in its entirety.

### TECHNICAL FIELD

This application relates to the field of electrochemical technology, and in particular, to a secondary battery and an electronic device.

### BACKGROUND

Lithium-ion batteries are widely used in the fields such as smartphones, wearable devices, consumable unmanned aerial vehicles, and electric vehicles by virtue of advantages such as a high energy density, a long cycle life, and no memory effect. In recent years, with rapid development of electric vehicles and portable electronic devices, people are imposing higher requirements on the safety performance, cycle performance, and the like of the lithium-ion batteries, and are expecting the rollout of a new lithium-ion battery with overall performance enhanced comprehensively.

Generally, an electrode plate of a lithium-ion battery expands in thickness greatly after chemical formation, that is, incurs a high expansion rate. When the thickness of the lithium-ion battery is constant, the high expansion rate of the electrode plate impairs the energy density of the lithium-ion battery. On the other hand, the lithium-ion battery may be used in special scenarios such as high temperatures and heating up in practical applications. In such scenarios, the lithium-ion battery is prone to thermal runaway or even catches fire and fails, thereby impairing the safety performance of the lithium-ion battery.

### SUMMARY

An objective of this application is to provide a secondary battery and an electronic device to improve the energy density and safety performance of the secondary battery. Specific technical solutions are as follows:

A first aspect of this application provides a secondary battery. The secondary battery includes a positive electrode plate. The positive electrode plate includes a positive current collector and a positive active material layer disposed on at least one side of the positive current collector. The positive active material layer includes a positive active material and a resin-based additive. Based on a mass of the positive active material layer, a mass percent of the resin-based additive is m %, where 0.1≤m≤2. When the positive electrode plate is baked at T ° C. for t minutes, 125≤T≤150, 5≤t≤30, a cohesive force of the positive active material layer before the baking is F₂ N/m, and a cohesive force of the positive active material layer after the baking is F₂ N/m, satisfying: F₂≥1.5F₁, and 30≤F₁≤100. A resistance of the positive electrode plate before the baking is R₁Ω, and a resistance of the positive electrode plate after the baking is R₂Ω, satisfying:

$${R}_{2} \geq {R}_{1} \times ( 1 + \frac{t}{60} ) ,$$

and 0.2≤R₁≤0.4. After baking, the cohesive force of the positive active material layer on the positive electrode plate of this application is increased, and can reduce the expansion rate of the positive electrode plate. Therefore, when the thickness of the secondary battery is constant, one or more layers of positive electrode plates can be disposed additionally to improve the energy density of the secondary battery. In addition, the resistance of the positive electrode plate of this application increases after being baked. Therefore, when the voltage is the same, the current of the secondary battery is reduced, thereby alleviating thermal runaway caused by internal heating of the secondary battery in a high-temperature environment, and in turn, improving safety performance of the secondary battery. By adjusting F₁, F₂, R₁, R₂, and t to satisfy the above relational expressions, both the energy density and safety performance of the secondary battery can be improved simultaneously.

In some embodiments of this application, the resin-based additive includes any one of the following structural units:

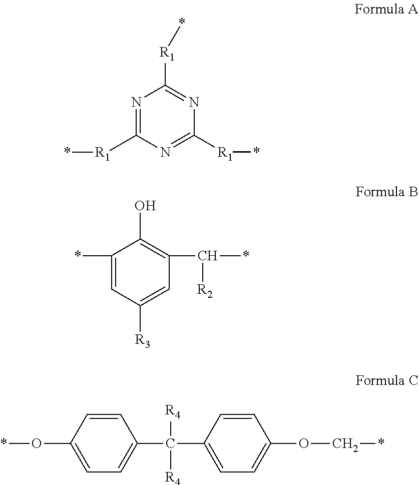

In the formulas above, R₁, R₂, and R₄ groups each independently include at least one of —NH₂, —NH—, —CN, HN═C(NH₂)—, HN═C(NH—)—, —CO—NH₂—, or —N═N—, and an R₃ group is a C₁₋₄ alkyl group. With the resin-based additive containing the structural unit that falls within the above range, the following beneficial effects are achieved: (i) good bonding properties of the resin-based additive can be exerted to improve the bonding force between the particles of the positive active material, and in addition, the nitrogen in the nitrogen-containing group in the above structural unit can combine with hydrogen in the positive electrode plate binder to form a hydrogen bond, thereby increasing an electrostatic attraction force of the positive active material and improving the cohesive force of the positive active material layer; (ii) the resin-based additive is crosslinked and solidified in a high-temperature environment to form a thin film on the surface of the positive active material, and the thin film can coordinate with the hydron bond to also increase the cohesive force of the positive active material layer after baking; and (iii) when the secondary battery assumes a tendency of thermal runaway, the thin film can impede electron transfer in the positive electrode plate, thereby further increasing the resistance of the positive electrode plate when the local temperature is abnormal, reducing the current of the secondary battery when the voltage is the same, alleviating the thermal runaway caused by internal heating of the secondary battery in a high-temperature environment, and further improving the safety performance of the secondary battery.

In some embodiments of this application, each R₁ group is independently selected from —R₁₁—NH—, HN═C(NH—)—R₁₂—, —CO—NH—, —N═N—R₁₃—, —R₁₄(CN)—, or —R₁₅(NH₂)—, where: R₁₁, R₁₂, and R₁₃ each are independently selected from a covalent bond or an Ra-substituted or unsubstituted C₁₋₄ alkylene group; and R₁₄ and R₁₅ each are independently selected from an Ra-substituted or unsubstituted C₁₋₄ alkylidene group; and Ra is selected from —NH₂, —CN, HN═C(NH₂)—, or —CO—NH₂. The R₂ and R₄ groups each are independently selected from —NH₂, —CN, HN═C(NH₂)—, —CO—NH₂, —R₂₁—CN, or —R₂₂—NH₂, where R₂₁ and R₂₂ each are independently selected from an Rb-substituted or unsubstituted C₁₋₄ alkylidene, and Rb is selected from —NH₂, —CN, HN═C(NH₂)—, or —CO—NH₂. The resin-based additive that includes the structural unit containing the above groups not only further increases the cohesive force of the positive active material layer, but also alleviates the thermal runaway caused by internal heating of the secondary battery in a high-temperature environment, thereby further improving the safety performance of the secondary battery.

In some embodiments of this application, the resin-based additive includes at least one of polymers represented by the following structural formulas:

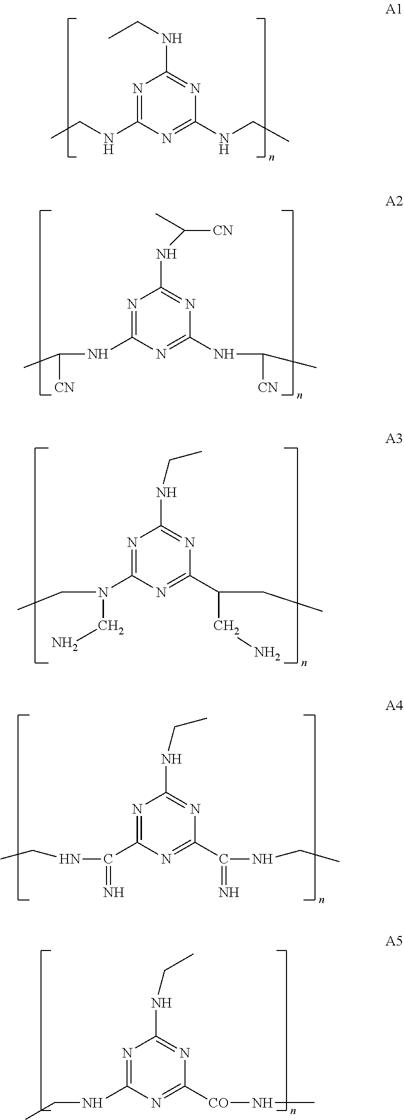

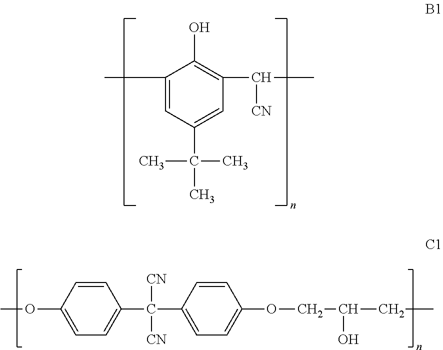

The resin-based additive that includes the polymer falling within the above range further increases the cohesive force of the positive active material layer, and reduces the expansion rate of the positive electrode plate, thereby increasing the energy density of the secondary battery.

In some embodiments of this application, the mass percent of the resin-based additive is m %, where 0.6≤m≤2. When the dosage of the resin-based additive in the electrode plate satisfies the above range, the cohesive force of the positive active material layer can be further increased, and the energy density of the secondary battery can be increased without impairing the working performance of the positive electrode plate, and the safety performance of the secondary battery can be further improved.

In some embodiments of this application, a weight-average molecular weight of the resin-based additive is 6000 to 20000, and a crosslinking density of the resin-based additive is 0.4 to 0.7. When the weight-average molecular weight and the crosslinking density of the resin-based additive fall within the above ranges, the processability of the positive electrode plate is higher, the cohesive force of the positive active material layer can be increased, the expansion rate of the positive electrode plate can be reduced, and the resistance of the positive electrode plate in a state of abnormal heat accumulation can be increased, thereby increasing the energy density of the secondary battery and alleviating the thermal runaway caused by the internal heat emission of the secondary battery in a high-temperature environment.

In some embodiments of this application, the resin-based additive includes at least one of: melamine formaldehyde resin or a derivative thereof, a phenolic resin derivative, or an epoxy resin derivative. The resin-based additive includes a nitrogen-containing group. Based on the mass of the positive active material layer, a mass percent of nitrogen is n %, where 0.0445≤n≤2.23. The resin-based additive includes the polymer falling within the above range, and the nitrogen content is adjusted to fall within the above range, so that the cohesive force of the positive active material layer is increased, and the expansion rate of the positive electrode plate is reduced. In addition, the resistance of the positive electrode plate in a state of abnormal heat accumulation is increased, thereby increasing the energy density of the secondary battery, and alleviating the thermal runaway caused by the internal heat emission of the secondary battery in a high-temperature environment.

In some embodiments of this application, a specific surface area of the positive active material is S m²/g, satisfying: 0.6S≤m≤3S. By adjusting the specific surface area S of the positive active material and the content m of the resin-based additive to satisfy the above relational expression, this application can exert the bonding effect of the resin-based additive, further increase the electrostatic attraction force of the positive active material, and in turn, increase the cohesive force of the positive active material layer. In addition, this increases the resistance of the positive electrode plate in a state of abnormal heat accumulation, thereby increasing the energy density of the secondary battery and alleviating the thermal runaway caused by the internal heat emission of the secondary battery in a high-temperature environment.

In some embodiments of this application, the specific surface area satisfies 0.1≤S≤1. By adjusting the specific surface area of the positive active material to fall within the above range, this application can further increase the electrostatic attraction force of the positive active material, and in turn, increase the cohesive force of the positive active material layer. In addition, this increases the resistance of the positive electrode plate in a state of abnormal heat accumulation, thereby increasing the energy density of the secondary battery and alleviating the thermal runaway caused by the internal heat emission of the secondary battery in a high-temperature environment.

In some embodiments of this application, a compaction density of the positive active material layer is 4.05 g/cm³ to 4.25 g/cm³. By adjusting the compaction density of the positive active material layer to fall within the above range, this application increases the cohesive force of the positive active material layer, thereby increasing the energy density of the secondary battery.

A second aspect of this application provides an electronic device, including the secondary battery according to the first aspect of this application. The secondary battery provided in this application possesses a high energy density and good safety performance, and therefore, the electronic device of this application possesses a long service life.

Beneficial effects of this application are as follows:

This application provides a secondary battery and an electronic device. The secondary battery includes a positive electrode plate. The positive electrode plate includes a positive current collector and a positive active material layer disposed on at least one side of the positive current collector. The positive active material layer includes a positive active material and a resin-based additive. Based on a mass of the positive active material layer, a mass percent of the resin-based additive is m %, where 0.1≤m≤2. When the positive electrode plate is baked at T ° C. for t minutes, 125≤T≤150, 5≤t≤30, a cohesive force of the positive active material layer before the baking is F₂ N/m, and a cohesive force of the positive active material layer after the baking is F₂ N/m, satisfying: F₂≥1.5F₁, and 30≤F₁≤100. A resistance of the positive electrode plate before the baking is R₁Ω, and a resistance of the positive electrode plate after the baking is R₂Ω, satisfying:

$${R}_{2} \geq {R}_{1} \times ( 1 + \frac{t}{60} ) ,$$

and 0.2≤R₁≤0.4. After baking, the cohesive force of the positive active material layer on the positive electrode plate of this application is increased, and can reduce the expansion rate of the positive electrode plate. Therefore, when the thickness of the secondary battery is constant, one or more layers of positive electrode plates can be disposed additionally to improve the energy density of the secondary battery. In addition, the resistance of the positive electrode plate of this application increases after being baked. Therefore, when the voltage is the same, the current of the secondary battery is reduced, thereby alleviating thermal runaway caused by internal heating of the secondary battery in a high-temperature environment, and in turn, improving safety performance of the secondary battery. By adjusting F₁, F₂, R₁, R₂, and t to satisfy the above relational expressions, both the energy density and safety performance of the secondary battery can be improved simultaneously.

Definitely, implementation of any one product or method according to this application does not necessarily achieve all of the foregoing advantages concurrently.

### DETAILED DESCRIPTION

The following clearly and fully describes the technical solutions in the embodiments of this application. Apparently, the described embodiments are merely a part of but not all of the embodiments of this application. All other embodiments derived by a person of ordinary skill in the art based on the embodiments of this application without making any creative efforts still fall within the protection scope of this application.

It is hereby noted that in specific embodiments of this application, this application is construed by using a lithium-ion battery as an example of the secondary battery, but the secondary battery of this application is not limited to the lithium-ion battery.

A first aspect of this application provides a secondary battery. The secondary battery includes a positive electrode plate. The positive electrode plate includes a positive current collector and a positive active material layer disposed on at least one side of the positive current collector. The positive active material layer includes a positive active material and a resin-based additive. Based on a mass of the positive active material layer, a mass percent of the resin-based additive is m %, where 0.1≤m≤2, and preferably, 0.6≤m≤2. For example, m may be 0.1, 0.3, 0.5, 1.0, 1.5, 1.8, 2.0, or a value falling within a range formed by any two thereof. When the positive electrode plate is baked at T ° C. for t minutes, 125≤T≤150, 5≤t≤30, a cohesive force of the positive active material layer before the baking is F₁ N/m, and a cohesive force of the positive active material layer after the baking is F₂ N/m, satisfying: F₂≥1.5F₁, and 30≤F₁≤100. For example, F₁ may be 30, 40, 50, 60, 70, 80, 90, 100, or a value falling within a range formed by any two thereof. A resistance of the positive electrode plate before the baking is R₁Ω, and a resistance of the positive electrode plate after the baking is R₂Ω, satisfying:

$${R}_{2} \geq {R}_{1} \times ( 1 + \frac{t}{60} ) ,$$

and 0.2≤R₁≤0.4. For example, R₁ may be 0.2, 0.25, 0.3, 0.35, 0.4, or a value falling within a range formed by any two thereof. After baking, the cohesive force of the positive active material layer on the positive electrode plate of this application is increased, and can reduce the expansion rate of the positive electrode plate. Therefore, when the thickness of the secondary battery is constant, one or more layers of positive electrode plates can be disposed additionally to improve the energy density of the secondary battery. In addition, the resistance of the positive electrode plate of this application increases after being baked. Therefore, when the voltage is the same, the current of the secondary battery is reduced, thereby alleviating thermal runaway caused by internal heating of the secondary battery in a high-temperature environment, and in turn, improving safety performance of the secondary battery. By adjusting m to fall within the above range and adjusting F₁, F₂, R₁, R₂, and t to satisfy the above relational expressions, both the energy density and safety performance of the secondary battery can be improved simultaneously.

In some embodiments of this application, the resin-based additive includes any one of the following structural units:

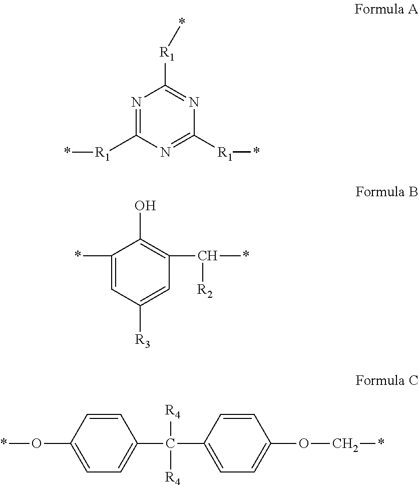

In the formulas above, R₁, R₂, and R₄ groups each independently include at least one of —NH₂, —NH—, —CN, HN═C(NH₂)—, HN═C(NH—)—, —CO—NH₂—, or —N═N—, and an R₃ group is a C₁₋₄ alkyl group. With the resin-based additive containing the structural unit that falls within the above range, the following beneficial effects are achieved: (i) good bonding properties of the resin-based additive can be exerted to improve the bonding force between the particles of the positive active material, and in addition, the nitrogen in the nitrogen-containing group in the above structural unit can combine with hydrogen in the positive electrode plate binder to form a hydrogen bond, thereby increasing an electrostatic attraction force of the positive active material and improving the cohesive force of the positive active material layer; (ii) the resin-based additive is crosslinked and solidified in a high-temperature environment to form a thin film on the surface of the positive active material, and the thin film can coordinate with the hydron bond to also increase the cohesive force of the positive active material layer after baking; and (iii) when the secondary battery assumes a tendency of thermal runaway, the thin film can impede electron transfer in the positive electrode plate, thereby further increasing the resistance of the positive electrode plate when the local temperature is abnormal, reducing the current of the secondary battery when the voltage is the same, alleviating the thermal runaway caused by internal heating of the secondary battery in a high-temperature environment, and further improving the safety performance of the secondary battery.

In some embodiments of this application, each R₁ group is independently selected from —R₁₁—NH—, HN═C(NH—)—R₁₂—, —CO—NH—, —N═N—R₁₃—, —R₁₄(CN)—, or —R₁₅(NH₂)—, where: R₁₁, R₁₂, and R₁₃ each are independently selected from a covalent bond or an Ra-substituted or unsubstituted C₁₋₄ alkylene group; and R₁₄ and R₁₅ each are independently selected from an Ra-substituted or unsubstituted C₁₋₄ alkylidene group; and Ra is selected from —NH₂, —CN, HN═C(NH₂)—, or —CO—NH₂. The R₂ and R₄ groups each are independently selected from —NH₂, —CN, HN═C(NH₂)—, —CO—NH₂, —R₂₁—CN, or —R₂₂—NH₂, where R₂₁ and R₂₂ each are independently selected from an Rb-substituted or unsubstituted C₁₋₄ alkylidene, and Rb is selected from —NH₂, —CN, HN═C(NH₂)—, or —CO—NH₂. The resin-based additive that includes the structural unit containing the above groups not only further increases the cohesive force of the positive active material layer, but also alleviates the thermal runaway caused by internal heating of the secondary battery in a high-temperature environment, thereby further improving the safety performance of the secondary battery.

Preferably, the resin-based additive may include at least one of a melamine formaldehyde resin (A1), a cyano melamine formaldehyde resin derivative (A2), an amino melamine formaldehyde resin (A3), an amidino melamine formaldehyde resin (A4), an amido melamine formaldehyde resin (A5), a cyano phenolic resin derivative (B1), or a cyano epoxy resin derivative (C1). Specifically, the structural formula of the resin-based additive is:

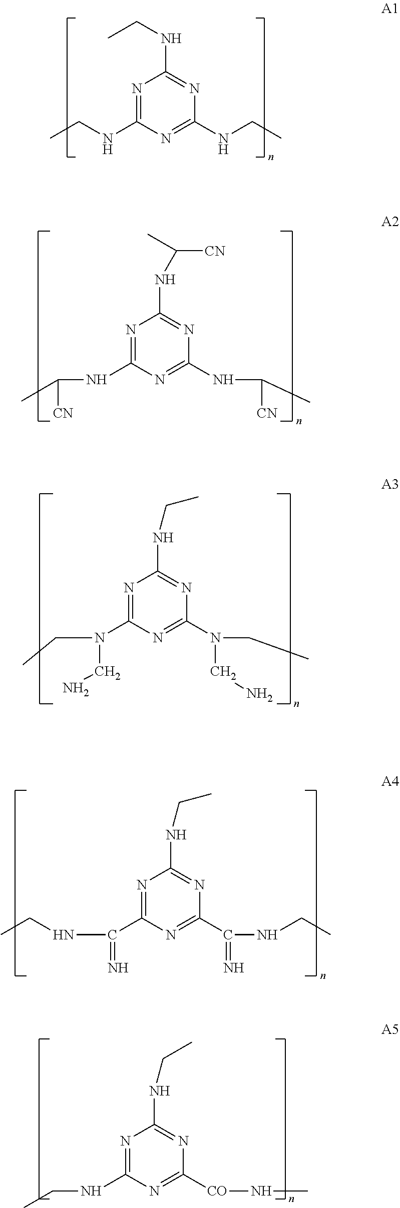

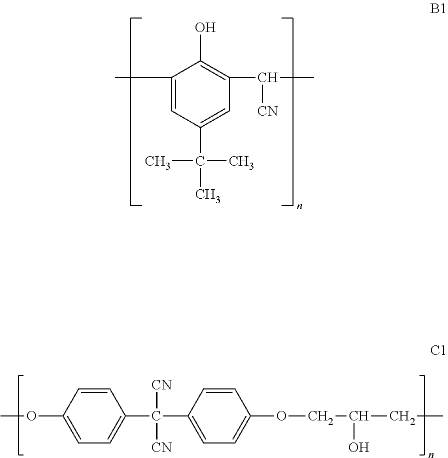

With the resin-based additive containing the polymer that falls within the above range, the following beneficial effects are achieved: (i) good bonding properties of the polymer can be exerted to improve the bonding force between the particles of the positive active material, and in addition, the nitrogen in the nitrogen-containing group can combine with hydrogen in the positive electrode plate binder to form a hydrogen bond, thereby increasing an electrostatic attraction force of the positive active material and improving the cohesive force of the positive active material layer; (ii) the polymer is crosslinked and solidified in a high-temperature environment to form a thin film on the surface of the positive active material, and the thin film can coordinate with the hydron bond to also increase the cohesive force of the positive active material layer after baking; and (iii) the thin film can impede electron transfer in the positive electrode plate, thereby further increasing the resistance of the positive electrode plate in a state of abnormal heat accumulation, reducing the current of the secondary battery when the voltage is the same, alleviating the thermal runaway caused by internal heating of the secondary battery in a high-temperature environment, and further improving the safety performance of the secondary battery. In some embodiments of this application, a weight-average molecular weight (Mw) of the resin-based additive is 6000 to 20000, and a crosslinking density of the resin-based additive is 0.4 to 0.7. For example, the Mw of the resin-based additive may be 6000, 8000, 10000, 12000, 15000, 18000, 20000, or a value falling within a range formed by any two thereof. The crosslinking density of the resin-based additive may be 0.4, 0.5, 0.55, 0.6, 0.7, or a value falling within a range formed by any two thereof. When the weight-average molecular weight and the crosslinking density of the resin-based additive fall within the above ranges, the processability of the positive electrode plate is higher, the cohesive force of the positive active material layer can be increased, the expansion rate of the positive electrode plate can be reduced, and the resistance of the positive electrode plate in a state of abnormal heat accumulation can be increased, thereby increasing the energy density of the secondary battery and alleviating the thermal runaway caused by the internal heat emission of the secondary battery in a high-temperature environment.

In some embodiments of this application, the resin-based additive includes at least one of: melamine formaldehyde resin or a derivative thereof, a phenolic resin derivative, or an epoxy resin derivative. The resin-based additive includes a nitrogen-containing group. Based on the mass of the positive active material layer, a mass percent of nitrogen is n %, where 0.0445≤n≤2.23. For example, n may be 0.0445, 0.05, 0.1, 0.2, 0.5, 0.8, 1, 1.5, 2.0, 2.2, 2.23, or a value falling within a range formed by any two thereof. The resin-based additive includes the polymer falling within the above range, and the nitrogen content is adjusted to fall within the above range, so that the cohesive force of the positive active material layer is increased, and the expansion rate of the positive electrode plate is reduced. In addition, the resistance of the positive electrode plate in a state of abnormal heat accumulation is increased, thereby increasing the energy density of the secondary battery, and alleviating the thermal runaway caused by the internal heat emission of the secondary battery in a high-temperature environment.

In this application, the resin-based additives are conventional materials that are commercially available. The source of the resin-based additives is not particularly limited in this application, as long as the objectives of this application can be achieved.

In some embodiments of this application, a specific surface area of the positive active material is S m²/g, satisfying: 0.6S≤m≤3S. By adjusting the specific surface area S of the positive active material and the content m of the resin-based additive to satisfy the above relational expression, this application can exert the bonding effect of the resin-based additive, further increase the electrostatic attraction force of the positive active material, and in turn, increase the cohesive force of the positive active material layer. In addition, this increases the resistance of the positive electrode plate in a state of abnormal heat accumulation, thereby increasing the energy density of the secondary battery and alleviating the thermal runaway caused by the internal heat emission of the secondary battery in a high-temperature environment.

In some embodiments of this application, 0.1≤S≤1. For example, S may be 0.1, 0.3, 0.4, 0.5, 0.7, 0.9, 1.0, or a value falling within a range formed by any two thereof. By adjusting the specific surface area of the positive active material to fall within the above range, this application can further increase the electrostatic attraction force of the positive active material, and in turn, increase the cohesive force of the positive active material layer. In addition, this increases the resistance of the positive electrode plate in a state of abnormal heat accumulation, thereby increasing the energy density of the secondary battery and alleviating the thermal runaway caused by the internal heat emission of the secondary battery in a high-temperature environment.

In some embodiments of this application, a compaction density of the positive active material layer is 4.05 g/cm³ to 4.25 g/cm³. For example, the compaction density of the positive active material layer may be 4.05 g/cm³, 4.1 g/cm³, 4.15 g/cm³, 4.2 g/cm³, 4.25 g/cm³, or a value falling within a range formed by any two thereof. By adjusting the compaction density of the positive active material layer to fall within the above range, this application increases the cohesive force of the positive active material layer, thereby increasing the energy density of the secondary battery.

The positive current collector is not particularly limited in this application, as long as the objectives of this application can be achieved. For example, the positive current collector may include aluminum foil, aluminum alloy foil, a composite current collector (such as an aluminum carbon composite current collector), or the like. The thickness of the positive current collector is not particularly limited in this application, as long as the objectives of this application can be achieved. For example, the thickness of the positive current collector is 5 μm to 20 μm.

The type of the positive active material is not particularly limited in this application, as long as the objectives of this application can be achieved. For example, the positive active material may include at least one of lithium nickel cobalt manganese (NCM) oxide, lithium nickel cobalt aluminum oxide, lithium iron phosphate, a lithium-rich manganese-based material, lithium cobalt oxide, lithium manganese oxide, lithium manganese iron phosphate, or the like. The type of the NCM is not particularly limited in this application, as long as the objectives of this application can be achieved. For example, the NCM may include at least one of NCM 811, NCM 622, NCM 523, or NCM 111. In this application, the positive active material may further include a non-metallic element. For example, the non-metallic elements include at least one of fluorine, phosphorus, boron, or chlorine. Such elements can further improve the stability of the positive active material. The thickness of the positive active material layer is not particularly limited in this application, as long as the objectives of this application can be achieved. For example, the thickness of the positive active material layer on a single side is 30 μm to 120 μm.

In this application, the positive active material layer may be disposed on one surface of the positive current collector in a thickness direction or on both surfaces of the positive current collector in the thickness direction. It is hereby noted that the “surface” here may be the entire region of the positive current collector, or a partial region of the positive current collector, without being particularly limited in this application, as long as the objectives of the application can be achieved.

In this application, the positive active material layer further includes a positive conductive agent. The conductive agent is not particularly limited in this application, as long as the objectives of this application can be achieved. For example, the conductive agent may include, but is not limited to, at least one of conductive carbon black (Super P), carbon nanotubes (CNTs), carbon fibers, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole.

In this application, the positive active material layer further includes a positive binder. The positive binder is not particularly limited in this application, as long as the objectives of this application can be achieved. For example, the positive binder may include, but is not limited to, at least one of polyacrylate, polyimide, polyamide, polyamide imide, polyvinylidene fluoride, polytetrafluoroethylene, polyvinyl alcohol, polyacrylonitrile, poly(styrene-co-butadiene), sodium alginate, sodium carboxymethyl cellulose, potassium carboxymethyl cellulose, sodium hydroxymethyl cellulose, or potassium hydroxymethyl cellulose.

The secondary battery of this application further includes a negative electrode plate. The negative electrode plate includes a negative current collector and a negative active material layer disposed on at least one side of the negative current collector. In this application, the negative active material layer may be disposed on one surface of the negative current collector in a thickness direction or on both surfaces of the negative current collector in the thickness direction. It is hereby noted that the “surface” here may be the entire region of the negative current collector, or a partial region of the negative current collector, without being particularly limited in this application, as long as the objectives of the application can be achieved. The thickness of the negative active material layer is not particularly limited in this application, as long as the objectives of this application can be achieved. For example, the thickness of the negative active material layer on a single side may be 30 μm to 160 μm.

The negative current collector is not particularly limited in this application, as long as the objectives of this application can be achieved. For example, the negative current collector may be copper foil, copper alloy foil, nickel foil, stainless steel foil, titanium foil, foamed nickel, foamed copper, a composite current collector (such as a carbon copper composite current collector, a nickel copper composite current collector, or a titanium copper composite current collector), or the like. The thickness of the negative current collector is not particularly limited in this application, as long as the objectives of this application can be achieved. For example, the thickness of the negative current collector is 4 μm to 10 μm.

In this application, the negative active material layer includes a negative active material. The negative active material is not particularly limited in this application, as long as the objectives of this application can be achieved. For example, the negative active material may include, but is not limited to, at least one of graphite, mesocarbon microbeads (MCMB), hard carbon, soft carbon, Li—Sn alloy, Li—Sn—O alloy, Sn, SnO, SnO₂, spinel-structured lithium titanium oxide Li₄Ti₅O₁₂, Li—Al alloy, or metallic lithium. The negative active material layer may further include a negative conductive agent. The negative conductive agent is not particularly limited in this application, as long as the objectives of this application can be achieved. For example, the negative conductive agent may include, but is not limited to, at least one of conductive carbon black (Super P), carbon black, carbon nanotubes (CNTs), carbon fibers, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole.

In this application, the negative active material layer may further include a negative binder. The negative binder is not particularly limited in this application, as long as the objectives of this application can be achieved. For example, the negative binder may include, but is not limited to, at least one of polyvinyl alcohol, carboxymethyl cellulose, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyvinylidene fluoride, polyethylene, polypropylene, polyacrylic acid, styrene-butadiene rubber, acrylated (acrylic) styrene-butadiene rubber, epoxy resin, or nylon.

In this application, the secondary battery further includes an electrolyte solution. The electrolyte solution includes a lithium salt and a nonaqueous solvent. The lithium salt may include at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato)borate (LiBOB), or lithium difluoroborate. The concentration of the lithium salt in the electrolyte solution is not particularly limited in this application, as long as the objectives of this application can be achieved. For example, the concentration of the lithium salt in the electrolyte solution is 0.9 mol/L to 1.5 mol/L. As an example, the concentration of the lithium salt in the electrolyte solution may be 0.9 mol/L, 1.0 mol/L, 1.1 mol/L, 1.3 mol/L, 1.5 mol/L, or a value falling within a range formed by any two thereof. The nonaqueous solvent is not particularly limited in this application, as long as the objectives of this application can be achieved. For example, the nonaqueous solvent may include, but is not limited to, at least one of a carbonate compound, a carboxylate compound, an ether compound, or other organic solvents. The carbonate compound may include, but is not limited to, at least one of a chain carbonate compound, a cyclic carbonate compound, or a fluorocarbonate compound. The chain carbonate compound may include, but is not limited to, at least one of dimethyl carbonate (DMC), diethyl carbonate (DEC), dipropyl carbonate (DPC), methyl propyl carbonate (MPC), ethylene propyl carbonate (EPC), or ethyl methyl carbonate (EMC). The cyclic carbonate compound may include, but is not limited to, at least one of ethylene carbonate (EC), propylene carbonate (PC), butylene carbonate (BC), or vinyl ethylene carbonate (VEC). The fluorocarbonate compound may include, but is not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvent may include, but is not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The secondary battery according to this application further includes a separator. The separator is not particularly limited in this application, as long as the objectives of this application can be achieved. For example, the separator may be made of a material including, but not limited to, at least one of polyethylene (PE)-based, polypropylene (PP)-based, or polytetrafluoroethylene-based polyolefin (PO) separator, a polyester film (such as polyethylene terephthalate (PET) film), a cellulose film, a polyimide film (PI), a polyamide film (PA), or a spandex or aramid film. The type of the separator may include, but is not limited to, a woven film, a non-woven film (non-woven fabric), a microporous film, a composite film, a calendered film, a spinning film, or the like. The separator according to this application may be a porous structure. The pore size of the separator is not particularly limited, as long as the objectives of this application can be achieved. For example, the pore size may be 0.01 μm to 1 μm. The thickness of the separator is not particularly limited in this application, as long as the objectives of this application can be achieved. For example, the thickness may be 5 μm to 500 μm.

The secondary battery of this application further includes a packaging bag. The packaging bag is configured to accommodate a positive electrode plate, a separator, a negative electrode plate, an electrolyte solution, and other components known in the art in the secondary battery. Such other components are not limited in this application. The packaging bag is not particularly limited in this application, and may be a packaging bag well known in the art, as long as the objectives of this application can be achieved.

The secondary battery is not particularly limited in this application, and may be any device in which an electrochemical reaction occurs. In an embodiment of this application, the secondary battery may be, but is not limited to, a lithium-ion secondary battery (lithium-ion battery), a lithium metal secondary battery, a lithium polymer secondary battery, a lithium-ion polymer secondary battery, or the like. In an embodiment, structures of the electrode assembly include a jelly-roll structure, a stacked structure, and the like.

The process of preparing the secondary battery in this application is well known to a person skilled in the art, and is not particularly limited in this application. For example, the preparation process may include, but is not limited to, the following steps: stacking the positive electrode plate, the separator, and the negative electrode plate in sequence, and performing operations such as winding and folding as required to obtain a jelly-roll electrode assembly; putting the electrode assembly into a package, injecting the electrolyte solution into the package, and sealing the package to obtain a secondary battery; or, stacking the positive electrode plate, the separator, and the negative electrode plate in sequence, and then fixing the four comers of the entire stacked structure by use of adhesive tape to obtain a stacked-type electrode assembly, putting the electrode assembly into a package, injecting the electrolyte solution into the package, and sealing the package to obtain a secondary battery. In addition, an overcurrent prevention element, a guide plate, and the like may be placed into the packaging bag as required, so as to prevent the rise of internal pressure, overcharge, and overdischarge of the secondary battery.

The packaging bag is not particularly limited in this application, and may be selected by a person skilled in the art as actually required, as long as the objectives of this application can be achieved. For example, the packaging bag may be an aluminum laminated film.

A second aspect of this application provides an electronic device, including the secondary battery according to the first aspect of this application. The secondary battery provided in this application possesses a high energy density and good safety performance, and therefore, the electronic device of this application possesses a long service life.

The electronic device according to this application is not particularly limited, and may be any electronic device known in the prior art. In some embodiments, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household battery, lithium-ion capacitor, or the like.

### EMBODIMENTS

The implementations of this application are described below in more detail with reference to embodiments and comparative embodiments. Various tests and evaluations are performed by the following methods. In addition, unless otherwise specified, the word “parts” means parts by mass, and the symbol “%” means a percentage by mass.

### ≤Test Methods and Test Devices

### Testing the Cohesive Force

(1) At a room temperature, charging the lithium-ion battery at a constant current of 0.2 C (rate) until the voltage increases from 3 V to fully-charged-state 4.45 V. Subsequently, removing the positive electrode plate from the fully-charged lithium-ion battery with a voltage of 4.45 V in a 25° C. environment, and wiping off the electrolyte residue on the surface of the electrode plate by using dust-free paper, so as to obtain a sample of the positive electrode plate.

(2) Taking the samples of the positive electrode plates removed from the fully-charged lithium-ion batteries prepared in each embodiment or each comparative embodiment, and dividing the samples into two groups, and baking one group in a muffle furnace at T ° C. for t minutes, where 125 S≤T≤150 and 5≤t≤30, but without baking the other group.

(3) Testing the cohesive force of the two groups of positive electrode plate samples according to the following steps: cutting out a positive electrode plate sample with a width of 30 mm and a length of 100 mm to 160 mm, sticking double-sided tape with a width of 20 mm and a length of 90 mm to 150 mm onto a steel sheet, sticking the positive electrode plate sample onto the double-sided tape in such a way that the test side faces downward, and then sticking green adhesive tape (with a width of 20 mm and a length of 90 mm to 150 mm) closely to the surface of the positive electrode plate. Subsequently, inserting a paper tape under the green tape, where the width of the paper tape is equal to the width of the electrode plate and the length of the paper tape is greater than the length of the sample by 80 mm to 200 mm. Fixing the paper tape by using crepe adhesive. Manually pushing a pressure roller with a mass of 2 kg to run over the test sample strip back and forth for 4 times to obtain a test sample. Testing the cohesive force by using a tensile tester (Instron 3365). Fixing the sample onto a test bed, folding the paper tape by 180°, and fixing the sample with a fixture. Adjusting the limiting block to an appropriate position, and setting the parameters of the test system to the following values: tension angle 180°, test width 20 mm, and test displacement 25 cm/min. Confirming that the load is reset to 0 and the displacement is reset to 0. Tapping “Start”, pulling the paper tape until the positive active material layer on the surface of the double-sided tape is detached from the positive current collector, and then ending the test. The system automatically outputs the measured cohesive force of the positive active material layer in the units of N/m.

### Testing the Resistance of the Positive Electrode Plate

(1) Taking a lithium-ion battery prepared in each embodiment or comparative embodiment, and obtaining two groups of positive electrode plate samples according to steps (1) and (2) in the cohesive force test method described above.

(2) Testing the resistance of the two groups of positive electrode plate samples by using a film resistance meter (manufactured by Initial Energy Science & Technology Co. Ltd.). Wiping the test probe of the film resistance meter clean with alcohol before testing, and then resetting the pressure and resistance to zero. Placing a cut-out positive electrode plate (60 mm×80 mm) flat on the sample holder, and then placing the sample holder in a test chamber. Selecting 12 different positions on each positive electrode plate sample for measuring, and then averaging out the measured values to obtain the resistance of the positive electrode plate in units of Q.

### Testing the Content of the Resin-Based Additive:

Removing the positive electrode plate from a fully charged lithium-ion battery in a 25° C. environment according to step (1) in the cohesive force test method described above. Measuring, by using an organic-element elemental analyzer (EA), the molar mass of nitrogen contained in the positive electrode plate sample obtained from the disassembled battery, and calculating the molar mass of the resin-based additive based on the molar mass of nitrogen.

### Hot-Oven Test:

Taking 10 lithium-ion battery samples from each embodiment or comparative embodiment, putting the samples into a 130° C. hot oven for testing according to the following steps: Leaving the lithium-ion batteries to stand for 5 minutes; charging the batteries at a constant current of 0.7 C until the voltage reaches 4.45 V, and then charging the batteries at a constant voltage until the current reaches 0.02 C, recording the open-circuit voltage (OCV) and the impedance (IMP) before the temperature is increased, and checking the appearance of the batteries and taking photographs; increasing the temperature of the lithium-ion batteries to 130° C.±2° C. at a rate of 5° C./min±2° C./min, maintaining the temperature for 60 minutes, and recording the surface temperature increment and voltage of the lithium-ion batteries; ending the test, recording the OCV and IMP, and checking the appearance of the batteries and taking photographs. Criterion for determining the test result: It is determined that a battery passes the hot-oven test if no fire or explosion occurs. Hot-oven test pass rate=(number of lithium-ion batteries passing the hot-oven test/10)×100%.

### Testing the Energy Density:

Charging and then discharging the lithium-ion battery in a 25° C. environment according to the following process to obtain the discharge capacity of the lithium-ion battery: charging the lithium-ion battery at a constant current of 0.5 C until the voltage reaches 4.45 V, and then charging the battery at a constant voltage of 4.45 V until the current reaches 0.025 C, leaving the battery to stand for 5 minutes, discharging the battery at a constant current of 0.5 C until the voltage reaches 3.0 V, and then leaving the battery to stand for 5 minutes, and obtaining the discharge capacity C. Measuring the length L, width W, and height H of the lithium-ion battery with a laser thickness gauge after completion of the above charging steps of the lithium-ion battery, so as to obtain the volume of the lithium-ion battery: V=L×W×H. Energy density (ED)=C/V, measured in Wh/L.

### Embodiment 1

### <Preparing a Positive Electrode Plate>

Dispersing the positive active material lithium cobalt oxide (LiCoO₂), conductive carbon black, the binder PVDF, and the melamine formaldehyde resin (Mw=8400) in an N-methyl-pyrrolidone solvent, and stirring well to obtain a slurry with a solid content of 70 wt % in which the mass ratio between LiCoO₂, conductive carbon black, binder, and melamine formaldehyde resin is 97.5:1.1:1.3:0.1. Coating one surface of a 9 μm-thick positive current collector aluminum foil with the positive electrode slurry evenly, and drying the slurry at 120° C. to obtain a positive electrode plate coated with a 110 μm-thick positive active material layer on a single side. Subsequently, repeating the above steps on the other surface of the positive current collector aluminum foil to obtain a positive electrode plate coated with the positive active material on both sides. Cold-pressing and cutting, after completion of the coating, the positive electrode plate into sheets of 74 mm×867 mm for future use. The compaction density of the positive electrode plate is 4.20 g/cm³.

### <Preparing a Negative Electrode Plate>

Mixing graphite as a negative active material, sodium carboxymethyl cellulose, carbon black as a negative conductive agent, and styrene-butadiene rubber at a mass ratio of 95:2:1:2, and then adding distilled water as a solvent, blending the mixture to form a negative electrode slurry with a solid content of 70 wt %, and stirring well. Coating one surface of a 6 μm-thick negative current collector copper foil with the negative electrode slurry evenly, and drying the slurry at 120° C. to obtain a negative electrode plate coated with a 150 μm-thick negative active material layer on a single side. Subsequently, repeating the foregoing coating step on the other surface of the negative current collector copper foil to obtain a negative electrode plate coated with the negative active material layer on both sides. Cold-pressing and cutting, after completion of the coating, the negative electrode plate into sheets of 78 mm×875 mm for future use. The compaction density of the negative electrode plate is 1.78 g/cm³.

### <Preparing an Electrolyte Solution>

Mixing diethyl carbonate (DEC), ethylene carbonate (EC), and propylene carbonate (PC) at a mass ratio of 1:1:1 in an dry argon atmosphere glovebox to form an organic solvent, and then adding a lithium salt hexafluorophosphate (LiPF₆) into the organic solvent to dissolve, and mixing the solution evenly to obtain an electrolyte solution in which the LiPF₆ concentration is 1.15 mol/L.

### <Separator>

Using a 16 μm-thick porous polyethylene film (manufactured by Celgard) as a separator.

### <Preparing a Lithium-Ion Battery>

Stacking the above-prepared positive electrode plate, separator, and negative electrode plate in sequence in such a way that the separator is located between the positive electrode plate and the negative electrode plate to serve a function of separation, and then winding the stacked structure to obtain an electrode assembly. Welding the tabs, and then putting the electrode assembly into an aluminum laminated film packaging shell, dehydrating the packaged electrode assembly in an 80° C. vacuum oven for 12 hours, and then injecting the prepared electrolyte solution. Performing steps such as vacuum sealing, standing, chemical formation, and aging to obtain a lithium-ion battery.

### Embodiments 2 to 17

Identical to Embodiment 1 except that the parameters are adjusted according to Table 1.

### Comparative Embodiments 1 to 3

Identical to Embodiment 1 except that the parameters are adjusted according to Table 1.

Table 1 shows the relevant parameters and performance test results in each embodiment and comparative embodiment.

TABLE 1

| | | | T | t | F₁ | F₂ | | | R₁ |
|---|---|---|---|---|---|---|---|---|---|
| | m | Resin-based additive | (° C.) | (min) | (N/m) | (N/m) | 1.5 F₁ | F₂ ≥ 1.5 F₁ | (Ω) |
| Embodiment 1 | 0.1 | Melamine | 135 | 15 | 31.07 | 47.98 | 46.61 | Satisfied | 0.247 |
| | | formaldehyde resin | | | | | | | |
| Embodiment 2 | 0.2 | Melamine | 135 | 15 | 56.73 | 87.60 | 85.1 | Satisfied | 0.207 |
| | | formaldehyde resin | | | | | | | |
| Embodiment 3 | 0.4 | Melamine | 135 | 15 | 59.68 | 90.07 | 89.52 | Satisfied | 0.229 |
| | | formaldehyde resin | | | | | | | |
| Embodiment 4 | 0.6 | Melamine | 135 | 15 | 64.02 | 96.87 | 96.03 | Satisfied | 0.235 |
| | | formaldehyde resin | | | | | | | |
| Embodiment 5 | 0.8 | Melamine | 135 | 15 | 66.76 | 102.30 | 100.14 | Satisfied | 0.246 |
| | | formaldehyde resin | | | | | | | |
| Embodiment 6 | 2.0 | Melamine | 135 | 15 | 99.03 | 150.13 | 148.55 | Satisfied | 0.272 |
| | | formaldehyde resin | | | | | | | |
| Embodiment 7 | 0.2 | Melamine | 135 | 15 | 54.68 | 82.67 | 82.02 | Satisfied | 0.225 |
| | | formaldehyde resin | | | | | | | |
| Embodiment 8 | 0.2 | Cyanophenolic | 135 | 15 | 38.78 | 60.19 | 58.17 | Satisfied | 0.281 |
| | | resin derivative | | | | | | | |
| Embodiment 9 | 0.2 | Cyanoepoxy resin | 135 | 15 | 45.02 | 70.09 | 67.53 | Satisfied | 0.234 |
| | | derivative | | | | | | | |
| Embodiment 10 | 0.2 | Cyanomelamine | 135 | 15 | 51.07 | 77.89 | 76.61 | Satisfied | 0.219 |
| | | formaldehyde resin | | | | | | | |
| | | derivative | | | | | | | |
| Embodiment 11 | 0.2 | Aminomelamine | 135 | 15 | 54.68 | 82.67 | 82.02 | Satisfied | 0.225 |
| | | formaldehyde resin | | | | | | | |
| Embodiment 12 | 0.2 | Cyanomelamine | 135 | 15 | 51.07 | 77.89 | 76.61 | Satisfied | 0.219 |
| | | formaldehyde resin | | | | | | | |
| | | derivative | | | | | | | |
| Embodiment 13 | 0.2 | Aminomelamine | 135 | 15 | 45.08 | 69.13 | 67.62 | Satisfied | 0.223 |
| | | formaldehyde resin | | | | | | | |
| Embodiment 14 | 0.2 | Aminomelamine | 135 | 15 | 37.01 | 58.14 | 55.52 | Satisfied | 0.237 |
| | | formaldehyde resin | | | | | | | |
| Embodiment 15 | 0.2 | Melamine | 135 | 15 | 37.34 | 57.01 | 56.01 | Satisfied | 0.253 |
| | | formaldehyde resin | | | | | | | |
| Embodiment 16 | 0.7 | Melamine | 135 | 15 | 65.97 | 104.46 | 98.96 | Satisfied | 0.241 |
| | | formaldehyde resin | | | | | | | |
| Embodiment 17 | 0.7 | Melamine | 135 | 15 | 65.76 | 104.74 | 98.64 | Satisfied | 0.221 |
| | | formaldehyde resin | | | | | | | |
| Comparative | 0 | Melamine | 135 | 15 | 15.64 | 14.16 | 23.46 | Not | 0.211 |
| Embodiment 1 | | formaldehyde resin | | | | | | satisfied | |
| Comparative | 0.05 | Melamine | 135 | 15 | 23.63 | 25.24 | 35.45 | Not | 0.217 |
| Embodiment 2 | | formaldehyde resin | | | | | | satisfied | |
| Comparative | 2.5 | Melamine | 135 | 15 | 103.25 | 147.33 | 154.88 | Not | 0.407 |
| Embodiment 3 | | formaldehyde resin | | | | | | satisfied | |

| | | | | | | | | Hot- | |
|---|---|---|---|---|---|---|---|---|---|
| | | | | | | | | oven | |
| | | | | | | | | test | |
| | | | | | | | | pass | Energy |
| | R₂ | R₁ × | R₂ ≥ R₁ × | S | 0.6 | 3.0 | 0.6 S ≤ | rate | density |
| | (Ω) | (1 + t/60) | (1 + t/60) | (m²/g) | S | S | m ≤ 3.0 S | (%) | (Wh/L) |
| Embodiment 1 | 0.423 | 0.309 | Satisfied | 0.15 | 0.09 | 0.45 | Satisfied | 100 | 696.82 |
| Embodiment 2 | 0.402 | 0.259 | Satisfied | 0.3 | 0.18 | 0.90 | Satisfied | 100 | 696.02 |
| Embodiment 3 | 0.420 | 0.286 | Satisfied | 0.3 | 0.18 | 0.90 | Satisfied | 100 | 696.89 |
| Embodiment 4 | 0.431 | 0.294 | Satisfied | 0.3 | 0.18 | 0.90 | Satisfied | 100 | 698.01 |
| Embodiment 5 | 0.452 | 0.308 | Satisfied | 0.3 | 0.18 | 0.90 | Satisfied | 100 | 698.64 |
| Embodiment 6 | 0.497 | 0.34 | Satisfied | 0.7 | 0.42 | 2.10 | Satisfied | 100 | 699.03 |
| Embodiment 7 | 0.413 | 0.281 | Satisfied | 0.25 | 0.15 | 0.75 | Satisfied | 100 | 695.23 |
| Embodiment 8 | 0.351 | 0.351 | Satisfied | 0.25 | 0.15 | 0.75 | Satisfied | 100 | 694.78 |
| Embodiment 9 | 0.295 | 0.293 | Satisfied | 0.25 | 0.15 | 0.75 | Satisfied | 100 | 695.04 |
| Embodiment 10 | 0.387 | 0.274 | Satisfied | 0.25 | 0.15 | 0.75 | Satisfied | 100 | 695.14 |
| Embodiment 11 | 0.413 | 0.281 | Satisfied | 0.25 | 0.15 | 0.75 | Satisfied | 100 | 695.23 |
| Embodiment 12 | 0.387 | 0.274 | Satisfied | 0.25 | 0.15 | 0.75 | Satisfied | 100 | 695.14 |
| Embodiment 13 | 0.351 | 0.279 | Satisfied | 0.25 | 0.15 | 0.75 | Satisfied | 100 | 695.33 |
| Embodiment 14 | 0.421 | 0.296 | Satisfied | 0.25 | 0.15 | 0.75 | Satisfied | 100 | 695.88 |
| Embodiment 15 | 0.459 | 0.316 | Satisfied | 0.1 | 0.06 | 0.30 | Satisfied | 100 | 695.98 |
| Embodiment 16 | 0.442 | 0.301 | Satisfied | 0.5 | 0.30 | 1.50 | Satisfied | 100 | 698.03 |
| Embodiment 17 | 0.421 | 0.276 | Satisfied | 1 | 0.60 | 3.00 | Satisfied | 100 | 698.7 |
| Comparative | 0.223 | 0.264 | Not | 0.25 | 0.15 | 0.75 | Not | 20 | 691.94 |
| Embodiment 1 | | | satisfied | | | | satisfied | | |
| Comparative | 0.247 | 0.271 | Not | 0.25 | 0.15 | 0.75 | Not | 27 | 689.17 |
| Embodiment 2 | | | satisfied | | | | satisfied | | |
| Comparative | 0.794 | 0.509 | Satisfied | 0.18 | 0.11 | 0.54 | Satisfied | 100 | 674.14 |
| Embodiment 3 | | | | | | | | | |

Note: When adjusting the content of the resin-based additive, the content of the conductive carbon black and the binder remains unchanged, and the aggregate mass percent of LiCoO₂ and the resin-based additive is constant 97.6%.

Overall, as can be seen from Embodiments 1 to 17 and Comparative Embodiments 1 to 3, after baking, the cohesive force of the positive active material layer on the positive electrode plate of this application is increased, and the resistance is increased. For the lithium-ion batteries prepared in the embodiments of this application, both the hot-oven test pass rate and the energy density are increased significantly, indicating that the lithium-ion batteries of this application possess a higher energy density and higher safety performance. The test result shows that, by adjusting and controlling F₁ and F₂ to satisfy F₂≥1.5F₁ and controlling R₁, R₂, and t to satisfy

$${R}_{2} \geq {R}_{1} \times ( 1 + \frac{t}{60} ) ,$$

this application can improve both the energy density and the safety performance of the lithium-ion batteries at the same time.

As can be seen from Embodiments 1 to 17 and Comparative Embodiments 1 to 3, when the resin-based additive is not added or the content of the resin-based additive is overly low, the hot-oven test pass rate of the lithium-ion battery is overly low, thereby is unfavorable to the safety performance of the lithium-ion battery. In addition, the expansion of the positive electrode plate is not alleviated, thereby also being unfavorable to the energy density of the lithium-ion battery. When the content of the resin-based additive is overly high, the content of the positive active material is relatively low, thereby reducing the energy density value of the lithium-ion battery and impairing the energy density of the lithium-ion battery. By controlling the content of the resin-based additive to fall within the range specified herein, the lithium ion battery achieves a higher energy density and higher safety performance concurrently.

Usually, the type of the resin-based additive affects the energy density and safety performance of the lithium-ion battery. As can be seen from Embodiments 7 to 14, when the resin-based additive falling within the range specified herein is applied to a positive electrode plate, the cohesive force of the positive active material layer on the positive electrode plate is increased after baking, the resistance is increased, and the lithium-ion battery achieves a high hot-oven test pass rate and a high energy density, indicating that the lithium-ion battery provided in this application possesses good safety performance and a high energy density.

As can be seen from Embodiments 15 to 17, by controlling S and m to satisfy the relational expression 0.6S≤m≤3S, this application achieves a lithium-ion battery with a high energy density and good safety performance.

Generally, the specific surface area of the positive active material affects the energy density of the lithium-ion battery. As can be further seen from Embodiments 15 to 17, by controlling the specific surface area of the positive active material to fall within the range specified herein, this application achieves a lithium-ion battery with a high energy density and good safety performance.

It is hereby noted that, the terms “include”, “comprise”, and any variation thereof are intended to cover a non-exclusive inclusion relationship in which a process, method, object, or device that includes or comprises a series of elements not only includes such elements, but also includes other elements not expressly specified or also includes inherent elements of the process, method, object, or device.

Different embodiments of this application are described in a correlative manner. For the same or similar part in one embodiment, reference may be made to another embodiment. Each embodiment focuses on differences from other embodiments.

What is described above is merely preferred embodiments of this application, but not intended to limit the protection scope of this application. Any modifications, equivalent replacements, improvements, and the like made without departing from the spirit and principles of this application still fall within the protection scope of this application.

What is claimed is:

1. A secondary battery, comprising: a positive electrode plate, the positive electrode plate comprises a positive current collector and a positive active material layer disposed on at least one side of the positive current collector; wherein,
the positive active material layer comprises a positive active material and a resin-based additive, and, based on a mass of the positive active material layer, a mass percent of the resin-based additive is m %, wherein 0.1≤m≤2;
when the positive electrode plate is baked at T ° C. for t minutes, 125≤T≤150, 5≤t≤30, a cohesive force of the positive active material layer before the baking is F₁ N/m, and a cohesive force of the positive active material layer after the baking is F₂ N/m, wherein F₂≥1.5F₁, and 30≤F₁≤100; and,
a resistance of the positive electrode plate before the baking is R₁Ω, and a resistance of the positive electrode plate after the baking is R₂Ω,
$${R}_{2} \geq {R}_{1} \times ( 1 + \frac{t}{60} ) ,$$
and 0.2≤R₁≤0.4.

2. The secondary battery according to claim 1, wherein the resin-based additive comprises any one of the following structural units: 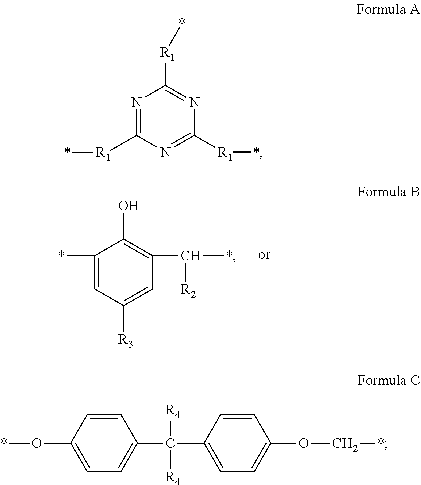
wherein,
each R₁ group independently comprises at least one selected from the group consisting of —NH₂, —NH—, —CN, HN═C(NH₂)—, HN═C(NH—)—, —CO—NH₂—, and —N═N—;
R₂ group comprises at least one selected from the group consisting of —NH₂, —NH—, —CN, HN═C(NH₂)—, HN═C(NH—)—, —CO—NH₂—, and —N═N—;
each R₄ group independently comprises at least one selected from the group consisting of —NH₂, —NH—, —CN, HN═C(NH₂)—, HN═C(NH—)—, —CO—NH₂—, and —N═N—; and,
R₃ group is a C₁₋₄ alkyl group.

3. The secondary battery according to claim 2, wherein,
the each R₁ group is independently any one selected from the group consisting of —R₁₁—NH—, HN═C(NH—)—R₁₂—, —CO—NH—, —N═N—R₁₃—, —R₁₄(CN)—, and —R₁₅(NH₂)—; wherein, R₁₁, R₁₂, and R₁₃ groups are each independently selected from a covalent bond or an Ra-substituted or unsubstituted C₁₋₄ alkylene group; and R₁₄ and R₁₅ groups are each independently selected from an Ra-substituted or unsubstituted C₁₋₄ alkylidene group; and Ra is any one selected from the group consisting of —NH₂, —CN, HN═C(NH₂)—, and —CO—NH₂;
R₂ group is any one selected from the group consisting of —NH₂, —CN, HN═C(NH₂)—, —CO—NH₂, —R₂₁—CN, and —R₂₂—NH₂; wherein, R₂₁ and R₂₂ groups are each independently selected from an Rb-substituted or unsubstituted C₁₋₄ alkylidene, and Rb is any one selected from the group consisting of —NH₂, —CN, HN═C(NH₂)—, and —CO—NH₂; and,
each R₄ groups is independently any one selected from the group consisting of —NH₂, —CN, HN═C(NH₂)—, —CO—NH₂, —R₂₁—CN, and —R₂₂—NH₂; wherein, R₂₁ and R₂₂ groups are each independently selected from an Rb-substituted or unsubstituted C₁₋₄ alkylidene, and Rb is any one selected from the group consisting of —NH₂, —CN, HN═C(NH₂)—, and —CO—NH₂.

4. The secondary battery according to claim 1, wherein the resin-based additive comprises at least one selected from the group consisting of polymers represented by the following formulas A1, A2, A3, A4, A5, B1 and C1:

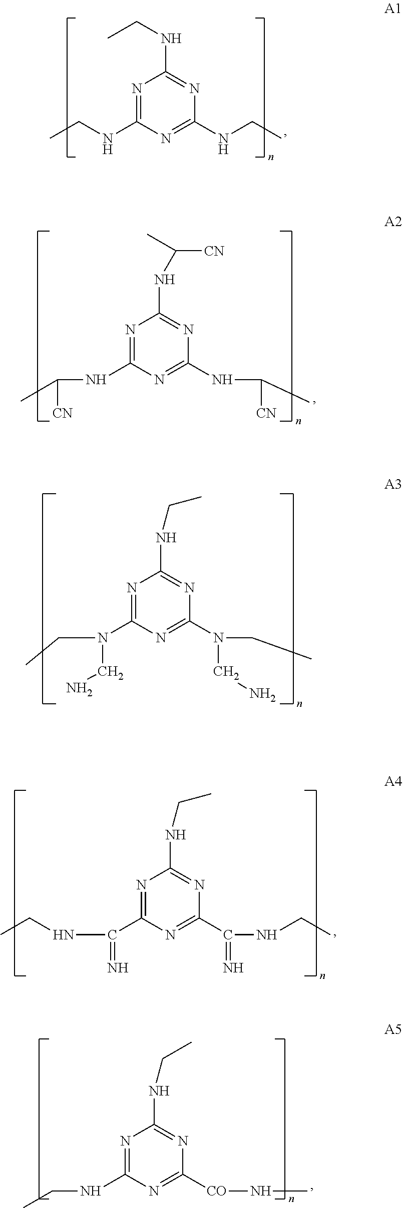

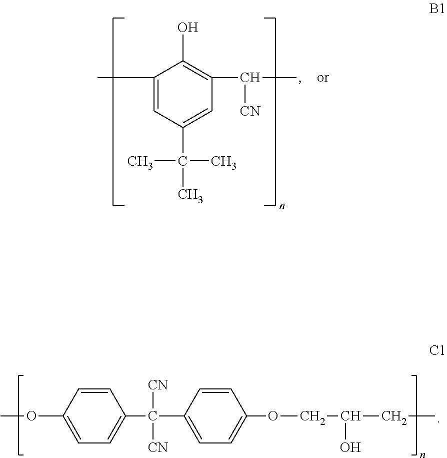

5. The secondary battery according to claim 1, wherein 0.6≤mn≤2.

6. The secondary battery according to claim 2, wherein a weight-average molecular weight of the resin-based additive ranges from 6000 to 20000, and a crosslinking density of the resin-based additive ranges from 0.4 to 0.7.

7. The secondary battery according to claim 2, wherein the resin-based additive comprises at least one selected from the group consisting of melamine formaldehyde resin or a derivative thereof, a phenolic resin derivative, and an epoxy resin derivative; and
the resin-based additive comprises a nitrogen-containing group, and, based on the mass of the positive active material layer, a mass percent of nitrogen is n %, wherein 0.0445≤n≤2.23.

8. The secondary battery according to claim 1, wherein a specific surface area of the positive active material is S m²/g, wherein 0.6S≤mn≤3S.

9. The secondary battery according to claim 8, wherein 0.1 S 1.

10. The secondary battery according to claim 1, wherein a compaction density of the positive active material layer range from 4.05 g/cm³ to 4.25 g/cm³.

11. An electronic device, comprising a secondary battery, wherein the secondary battery comprises:
a positive electrode plate, the positive electrode plate comprises a positive current collector and a positive active material layer disposed on at least one side of the positive current collector; wherein,
the positive active material layer comprises a positive active material and a resin-based additive, and, based on a mass of the positive active material layer, a mass percent of the resin-based additive is m %, wherein 0.1≤m≤2;
when the positive electrode plate is baked at T ° C. for t minutes, 125≤T≤150, 5≤t≤30, a cohesive force of the positive active material layer before the baking is F₁ N/m, and a cohesive force of the positive active material layer after the baking is F₂ N/m, wherein F₂≥1.5F₁, and 30≤F₁≤100; and,
a resistance of the positive electrode plate before the baking is R₁Ω, and a resistance of the positive electrode plate after the baking is R₂Ω, wherein
$${R}_{2} \geq {R}_{1} \times ( 1 + \frac{t}{60} ) ,$$
and 0.2≤R₁≤0.4.

12. The electronic device according to claim 11, wherein the resin-based additive comprises any one of the following structural units: 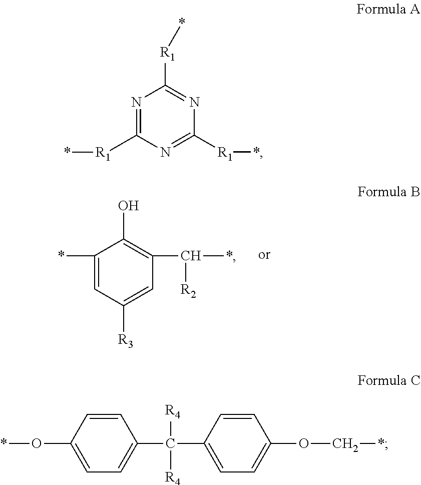
wherein,
each R₁ group independently comprises at least one selected from the group consisting of —NH₂, —NH—, —CN, HN═C(NH₂)—, HN═C(NH—)—, —CO—NH₂—, and —N═N—;
R₂ group comprises at least one selected from the group consisting of —NH₂, —NH—, —CN, HN═C(NH₂)—, HN═C(NH—)—, —CO—NH₂—, and —N═N—;
each R₄ group independently comprises at least one selected from the group consisting of —NH₂, —NH—, —CN, HN═C(NH₂)—, HN═C(NH—)—, —CO—NH₂—, and —N═N—; and,
R₃ group is a C₁₋₄ alkyl group.

13. The electronic device according to claim 12, wherein,
the each R₁ group is independently any one selected from the group consisting of —R₁₁—NH—, HN═C(NH—)—R₁₂—, —CO—NH—, —N═N—R₁₃—, —R₁₄(CN)—, and —R₁₅(NH₂)—; wherein, R₁₁, R₁₂, and R₁₃ groups are each independently selected from a covalent bond or an Ra-substituted or unsubstituted C₁₋₄ alkylene group; and R₁₄ and R₁₅ groups are each independently selected from an Ra-substituted or unsubstituted C₁₋₄ alkylidene group; and Ra is any one selected from the group consisting of —NH₂, —CN, HN═C(NH₂)—, and —CO—NH₂;
R₂ group is any one selected from the group consisting of —NH₂, —CN, HN═C(NH₂)—, —CO—NH₂, —R₂₁—CN, and —R₂₂—NH₂; wherein, R₂₁ and R₂₂ groups are each independently selected from an Rb-substituted or unsubstituted C₁₋₄ alkylidene, and Rb is any one selected from the group consisting of —NH₂, —CN, HN═C(NH₂)—, and —CO—NH₂; and,
each R₄ groups is independently any one selected from the group consisting of —NH₂, —CN, HN═C(NH₂)—, —CO—NH₂, —R₂₁—CN, and —R₂₂—NH₂; wherein, R₂₁ and R₂₂ groups are each independently selected from an Rb-substituted or unsubstituted C₁₋₄ alkylidene, and Rb is any one selected from the group consisting of —NH₂, —CN, HN═C(NH₂)—, and —CO—NH₂.

14. The electronic device according to claim 11, wherein the resin-based additive comprises at least one selected from the group consisting of polymers represented by the following formulas A1, A2, A3, A4, A5, B1 and C1:

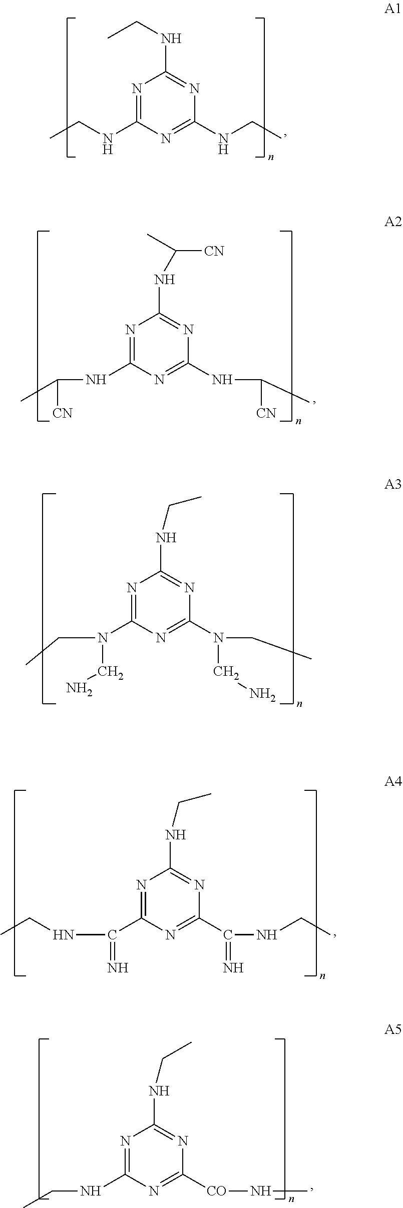

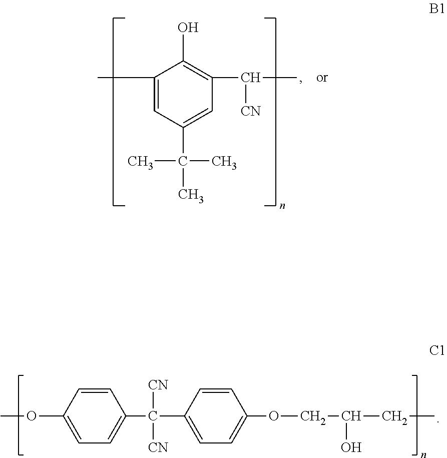

15. The electronic device according to claim 11, wherein 0.6≤m≤2.

16. The electronic device according to claim 12, wherein a weight-average molecular weight of the resin-based additive ranges from 6000 to 20000, and a crosslinking density of the resin-based additive ranges from 0.4 to 0.7.

17. The electronic device according to claim 12, wherein the resin-based additive comprises at least one selected from the group consisting of melamine formaldehyde resin or a derivative thereof, a phenolic resin derivative, and an epoxy resin derivative; and
the resin-based additive comprises a nitrogen-containing group, and, based on the mass of the positive active material layer, a mass percent of nitrogen is n %, wherein 0.0445≤n≤2.23.

18. The electronic device according to claim 11, wherein a specific surface area of the positive active material is S m²/g, wherein 0.6S≤m≤3S.

19. The electronic device according to claim 18, wherein 0.1≤S≤1.

20. The electronic device according to claim 11, wherein a compaction density of the positive active material layer range from 4.05 g/cm³ to 4.25 g/cm³.
